(19) United States
(12) Patent Application Publication
(10) Pub. No.: US 2017/0270557 A1
(43) Pub. Date: Sep. 21, 2017

(54) METHOD AND SYSTEM FOR TOKENIZATION OF REWARD DATA

(71) Applicant: MasterCard International Incorporated, Purchase, NY (US)

(72) Inventors: Pia MAENPAA, White Plains, NY (US); Danielle Jean EININGER, New City, NY (US); Matthew HARRIS, St. Peters, MO (US); Heather L. THOMAS, Brooklyn, NY (US)

(73) Assignee: MasterCard International Incorporated, Purchase, NY (US)

(21) Appl. No.: 15/071,378

(22) Filed: Mar. 16, 2016

(51) Int. Cl. G06Q 30/02; G06Q 20/36; G06Q 20/32; G06Q 20/20

(52) U.S. Cl. CPC G06Q 30/0233; G06Q 20/20; G06Q 20/363; G06Q 20/327

(57) ABSTRACT

A method for tokenizing non-payment identifier, comprising storing a plurality of account profiles, wherein each account profile is a structured data set related to a transaction account including at least a non-payment identifier, at least one of a personal account number (PAN), and quantity of points affiliated with the non-payment identifier. Receiving a data signal from a consumer communication device, wherein the data signal may be superimposed with a tokenization request, the tokenization request including at least a non-payment identifier. Provisioning, by a generation module of the processing server, a token linking to the non-payment identifier. Transmitting, by a transmitting device of the processing server, the token linked to the non-payment identifier to the consumer communication device.

### FIELD

The present disclosure relates to the tokenization of reward data, specifically the tokenizing of rewards and loyalty point accounts in a mobile device for use at standard point of sale terminals, to permit digital secure remote payments, and for use in e-commerce.

### BACKGROUND

For many years now, businesses such as airlines, hotels, retail stores, and rental cars have used reward programs to maintain their customer base and to attract new customers. In many of these programs, a customer earns points for undertaking some activity, such as taking flights on a particular airline or a companion airline. In some programs, points may be earned by simply charging purchased items to a particular type of credit card. The points that are earned in these programs can be redeemed for various goods and services. As more and more of these programs come into existence, there becomes a need for new and innovative programs for maintaining the loyalty of one's customer base as well as for enhancing the customer base. There are hundreds of rewards programs in which consumers can participate. Some, for example, may be airlines miles and/or hotel points. However, there are limitations on the purchasing power of consumers using reward points. For example, airlines miles may only be used to purchase tickets or apply for upgrades and hotel points may only be used with the particular hotel. If there are not enough points for the purchase the consumer desires they must wait or they may be able to buy more points using money. This can be both disappointing and cumbersome for consumers.

Thus, there is a need for a technical solution to digitize points for these programs so that they can be used flexibly as payment vehicles providing a more unlimited funding method allowing all desired purchases whether the points balance is sufficient or not. This would provide a consumer with flexibility in how they choose to use their rewards and/or loyalty points at any time, not just when they have accumulated a certain amount required.

### SUMMARY

The present disclosure provides a description of systems and methods for tokenizing non-payment identifiers comprising storing, in an account database of a processing server, a plurality of account profiles. Each account profile may be a structured data set related to a transaction account including at least a non-payment identifier, at least one of a personal account number (PAN), and quantity of points affiliated with the non-payment identifier. In some implementations, the non-payment identifier may be for a loyalty account based on at least one of: an airline, a retail merchant, a gym, an employer, a gas station, a grocery store, a pharmacy, a hotel, a financial institution, and/or a restaurant. The PAN may comprise of at least one: a credit card, a debit card, a checking account number, and/or a savings account number. A receiving device of the processing server may receive a data signal from a consumer communication device. The data signal may be superimposed with a tokenization request, the tokenization request may include at least a non-payment identifier. A generation module of the processing server may provision a token linking to the non-payment identifier. A transmitting device of the processing server may transmit the token linked to the non-payment identifier to the consumer communication device.

A method for linking a token to a ticket identifier may comprise storing, in an account database of a processing server, a plurality of account profiles. Each account profile may be a structured data set related to a transaction account including at least an account identifier, at least one of a personal account number (PAN) and a loyalty account, and at least one ticket identifier. The ticket identifier may permit access to an event. A receiving device of the processing server may receive a data signal from a consumer communication device. The data signal may be superimposed with a ticket purchase request. The ticket purchase request may include at least a ticket identifier and an account identifier. A generation module of the processing server may generate a token linked to the ticket identifier, the token being limited to use for purchases within the event. A transmitting device of the processing server may transmit a data signal to the consumer communication device. The data signal may be superimposed with a ticket identifier and the token linked to the ticket identifier. The receiving device of the processing server may receive a transaction authorization request to purchase an item during the event. The transaction authorization request may comprise the ticket identifier and a transaction amount for the item. A processing device of the processing server may determine if the token is being used for a purchase within the event. When the token is being used for the purchase within the event, the processing device of the processing server may map the token to a PAN or a loyalty account when available. The receiving device of the processing server may receive an authorization response with mapping of the PAN or loyalty account back to token. The processing device of the processing server may determine an event ending and charge the account profile to provide payment for the amount charged to the ticket identifier during the event.

A system for tokenizing a non-payment identifier may comprise an account database of a processing server configured to store a plurality of account profiles. Each account profile may be a structured data set related to a transaction account including at least a non-payment identifier, at least one of a personal account number (PAN), and quantity of points affiliated with the non-payment identifier. A receiving device of the processing server may be configured to receive a data signal from a consumer communication device. The data signal may be superimposed with a tokenization request, the tokenization request including at least a non-payment identifier. A generation module of the processing server may be configured to provision a token linking to the non-payment identifier. A transmitting device of the processing server may be configured to transmit the token linked to the non-payment identifier to the consumer communication device.

A system for linking a token to a ticket identifier may comprise an account database of a processing server configured to store a plurality of account profiles. Each account profile may be a structured data set related to a transaction account including at least an account identifier, at least one of a personal account number (PAN) and a loyalty account, and at least one ticket identifier. The ticket identifier may permit access to an event. A receiving device of the processing server may be configured to receive a data signal from a consumer communication device. The data signal may be superimposed with a ticket purchase request. The ticket purchase request may include at least a ticket identifier and an account identifier. A generation module of the processing server may be configured to generate a token linked to the ticket identifier. The token may be limited to use for purchases within the event. A transmitting device of the processing server may be configured to transmit a data signal to the consumer communication device. The data signal may be superimposed with a ticket identifier and the token linked to the ticket identifier. The receiving device of the processing server may be configured to receive a transaction authorization request to purchase an item during the event. The transaction authorization request may comprise the ticket identifier and a transaction amount for the item. A processing device of the processing server may be configured to determine if the token is being used for a purchase within the event. When the token is being used for the purchase within the event, the processing device of the processing server may be configured to map the token to a PAN or a loyalty account when available. The receiving device of the processing server may be configured to receive an authorization response with mapping of the PAN or loyalty account back to token. The processing device of the processing server may be configured to determine an event ending and charging the account profile to provide payment for the amount charged to the ticket identifier during the event.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high-level system architecture for the tokenization of reward data in accordance with exemplary embodiments.

FIG. 2 is a block diagram illustrating the processing server of FIG. 1 for the tokenization of reward data in accordance with exemplary embodiments.

FIG. 3 is a block diagram illustrating the account database of the processing server of FIG. 2 for the tokenizing of reward data in accordance with exemplary embodiments.

FIG. 4 is a flow diagram illustrating a process for tokenization of reward data using the system of FIG. 1 in accordance with exemplary embodiments.

FIG. 5 is a flow chart illustrating an exemplary method for tokenization of reward data in accordance with exemplary embodiments.

FIG. 6 is a flow diagram illustrating the processing of a payment transaction in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have and require special knowledge in offered products. In some embodiments, an entity involved in a single transaction may be considered a merchant. In some instances, as used herein, the term “merchant” may refer to an apparatus or device of a merchant entity.

Payment Account—A financial account that may be used to fund a transaction, such as a checking account, savings account, credit account, virtual payment account, etc. A payment account may be associated with an entity, which may include a person, family, company, corporation, governmental entity, etc. In some instances, a payment account may be virtual, such as those accounts operated by PayPal®, etc.

Payment Card—A card or data associated with a payment account that may be provided to a merchant in order to fund a financial transaction via the associated payment account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated payment account (e.g., as stored in a communication device, such as a smart phone or computer). For example, in some instances, data including a payment account number may be considered a payment card for the processing of a transaction funded by the associated payment account. In some instances, a check may be considered a payment card where applicable.

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

### System for Tokenizing Reward Data

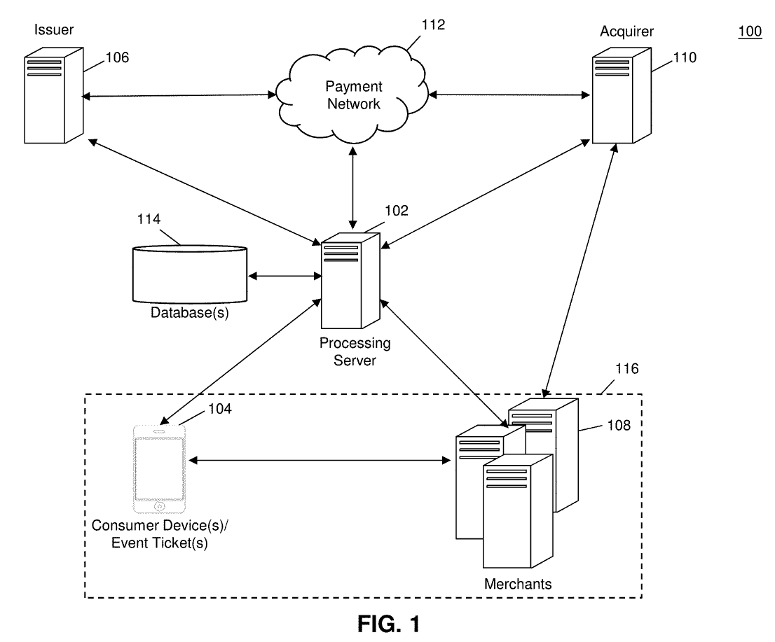

FIG. 1 is a block diagram illustrating a high-level system architecture 100 for the tokenization of reward data in accordance with exemplary embodiments.

The system 100 may include a processing server 102. The processing server 102, discussed in more detail below, may be configured to tokenize reward data and electronically distribute controlled payment tokens to mobile devices for use in conducting payment transactions. Payment tokens may be associated with a transaction account and may be used in place of traditional payment credentials in an electronic payment transaction conducted at a merchant. The payment transaction may be processed with the payment token in place of the traditional payment credentials using traditional methods and systems. During the processing of such payment transactions, the associated transaction account may be identified and used for funding of the payment transaction. Payment tokens may be provisioned to a mobile computing device and may be uniquely associated with that mobile computing device such that the processing of the payment transaction may include identification of the mobile computing device used in the transaction and verification that the payment token presented for use in the transaction is the same payment token provisioned to, and thus uniquely associated with the mobile computing device.

In the system 100, the processing server 102 may provision a payment token for a transaction account to a consumer device 104. In some implementations, the payment token may be linked to an event ticket, which may be a physical ticket and/or be an electronic ticket, which is presented on the consumer device 104. The consumer device 104, which may also be referred to herein as a “primary” mobile device, may be any type of mobile device suitable for the receipt and usage of payment tokens for use in electronic payment transactions, such as a cellular phone, smart phone, tablet computer, laptop computer, notebook computer, smart phone, wearable computing device, implantable computing device, etc. The event ticket may be any ticket used by a consumer to conduct an activity such as check in at an airport for a flight, attend a concert, participate in a golf tournament, attend a networking seminar, and/or any other event where a consumer presents a ticket to attend.

For example, rewards and loyalty point accounts may be digitized and tokenized so that they can be used at standard POS merchant terminals, and also for digital secure remote payments and e-commerce. In an exemplary embodiment, a consumer's airline loyalty card and flight ticket can be tokenized into the consumer's mobile device so that the consumer is able to charge any incidentals on their awards account during their trip. Primarily, the consumer's points may be deducted for payments and if point balance is exhausted then payment may be made with the credit card and/or any other payment method used for the trip and/or linked to the consumer's awards account.

In some embodiments, the processing server 102 may indicate the payment token provisioned to the consumer device 104 to be a “parent” payment token, in that it is the initial payment token provisioned for the transaction account, and that the consumer device 104 may be used in the distribution of tokens to secondary devices.

The processing server 102 may store such data in a database 114 (e.g., account database), discussed in more detail below, that may store an account profile related to the transaction account that includes the payment token, its status, and an identifier associated with the consumer device 104 to which the payment token is associated. The identifier associated with the consumer device 104, referred to herein as a “device identifier,” may be any value suitable for use in identification of the consumer device 104 and the associated account profile. The device identifier may be, for example, a username, e-mail address, telephone number, identification number, registration number, serial number, media access control address, internet protocol address, etc.

The processing server 102 may store, in the database 114, a plurality of account profiles. Each account profile may be a structured data set related to a transaction account including at least a non-payment identifier, at least one of a personal account number (PAN), and quantity of points affiliated with the non-payment identifier. In some implementations, the non-payment identifier may be for a loyalty account based on at least one of: an airline, a retail merchant, a gym, an employer, a gas station, a grocery store, a pharmacy, a hotel, a financial institution, and a restaurant. In some implementations, the PAN may comprise at least one of: a credit card, a debit card, a checking account number, and/or a savings account number.

In some implementations, each account profile may be a structured data set related to a transaction account including at least an account identifier, at least one of a personal account number (PAN) and a loyalty account, and at least one ticket identifier. The ticket identifier may permit access to an event. The event may be predefined by participating merchants. For example, during a networking seminar, merchants participating in the seminar may define the seminar as an event. The merchants may be able to determine the starting period, the ending period, and/or any limits for spending loyalty and/or rewards points. The account identifier may include at least one of: a phone number, application identifier, username, identification number, media access control address, device fingerprint, e-mail address, personal identification number, and authentication credentials.

The processing server 102 may receive a data signal from a consumer device 104. The data signal may be superimposed with a tokenization request, which may include at least a non-payment identifier. The processing server 102 may provision a token linking to the non-payment identifier and transmit the token linked to the non-payment identifier to the consumer device 104.

The processing server 102 may receive a transaction authorization request to purchase an item. The transaction authorization request may comprise the token linked to the non-payment identifier and a transaction amount for the item. The processing server 102 may determine the quantity of points affiliated with the non-payment identifier. When the quantity of the points is equal to or greater than the transaction amount, the processing server 102 may withdraw the points needed from the quantity of points affiliated with the non-payment identifier for the transaction amount and approving the payment. When the quantity of points are less than the transaction amount, the processing server 102 may subtract the difference between the transaction amount and the quantity of points affiliated with the non-payment identifier, and charge the difference to at least one of the PAN affiliated with the non-payment identifier and a PAN affiliated with a loyalty administrator account. In some implementations, wherein there are enough points to cover the transaction, the consumer will not be charged, however, the points and/or loyalty administrator's payment method may be charged to cover the transaction. In other implementations, where there are not enough points to cover the transaction, the points and/or loyalty administrator may pay for the covered amount, and the consumer may pay for the exceeding amount. In this case, two payment methods (e.g., PANs) may be used to cover the transaction. By design, both the consumer's backup payment method (e.g., consumer PAN) and the points and/or loyalty administrator's payment method (e.g., admin PAN) are linked to the non-payment account and its token. In some implementations, the points and/or loyalty administrator could also have another agreement with the merchant so that instead of payment in money, the charge could be accumulated and/or covered by reciprocity purchases or a similar swap. The de-tokenization service may then send the amount covered by the points to be paid by the points and/or loyalty administrator's payment method and the not-covered amount to be paid by the consumer's payment method.

In some implementations, the processing server 102 may receive a data signal from a consumer device 104. The data signal may be superimposed with a ticket purchase request including at least a ticket identifier and an account identifier.

The processing server 102 may generate a token linked to the ticket identifier. In some implementations, the token may be limited to use for purchases within the event. The token may include a payment limit associated with the ticket identifier, which may be set by the consumer device 104.

The processing server 102 may transmit a data signal to the consumer communication device. The data signal may be superimposed with a ticket identifier and the token linked to the ticket identifier. The processing server 102 may receive a transaction authorization request to purchase an item during the event. The transaction authorization request may comprise the ticket identifier and a transaction amount for the item. The purchase of an item within the event may comprise one or more of: making purchases in a geographically bound location 116 of the event, making purchases with particular vendors (e.g., merchants 108) of the event, and making purchases within a time period of the event. For example, when the event is a consumer making a flight, the geographically bound location 116 may be an airport. The merchants 108 within the geographically bound location 116 may be any vendors at the airport, which may provide goods and/or services to the consumer. The event ticket and/or consumer device 104 linked to the tokens may be the flight ticket of the consumer linked to their loyalty account.

The processing server 102 may determine if the token used for a purchase qualifies as within the event. When the token is used for a purchase within the event, the processing server 102 may map the token to a PAN or a loyalty account when available. The processing server 102 may receive an authorization response with mapping of the PAN or loyalty account back to token, and determine an event ending. The processing server may 102 charge the account profile to provide payment for the amount charged to the ticket identifier during the event. In some implementations, charging the account profile comprises utilizing loyalty points affiliated with the loyalty account. For example, the consumer's loyalty rewards linked to their loyalty account can be used to make purchases in the airport by the consumer presenting their ticket and/or consumer device 104.

In some implementations, a consumer may share their loyalty reward points with a second consumer in the capacity of a sender. A sender may be a user of the consumer device 104. The sender may identify a recipient to which the sender wants to provide access to their transaction account. The sender may identify a recipient mobile device, or “secondary” mobile device, associated with the recipient to whom a secondary, or “child,” payment token may be provisioned that is associated with their transaction account. The sender and/or consumer device 104 may obtain a device identifier associated with the recipient mobile device. The device identifier may be obtained from the recipient, such as by the sender directly asking the recipient, or directly from the recipient mobile device by the sender or by an electronic transmission from the recipient mobile device to the consumer device 104 via a suitable communication network, such as a cellular communication network and/or the Internet. In instances where the sender may obtain the device identifier associated with the recipient mobile device, the sender may input the device identifier into the consumer device 104 using an input device.

Once the consumer device 104 has obtained the device identifier of the recipient mobile device to which the sender wants to distribute a payment token linked to their loyalty rewards account, the sender may initiate the electronic transmission of a data signal from the consumer device 104 to the processing server 102 that is superimposed with a token distribution request. The data signal may be electronically transmitted using any suitable communication network, such as a cellular communication network or the Internet. The token distribution request may include at least the device identifier associated with the consumer device 104, the device identifier associated with the recipient mobile device, and an account identifier. The account identifier may be an identification value associated with the transaction account (e.g., loyalty account) to which the sender wants to provide the recipient with access. The account identifier may be, for example, the primary account number, an identification number, a name, etc.

In some embodiments, the token distribution request may also include one or more account controls. Account controls may be controls to be associated with the payment token such that payment transactions where the payment token is presented as the funding source are subject to the account controls and must be in compliance with the account controls to be approved. A payment token subject to one or more account controls may be referred to herein as a “controlled token” or “controlled payment token.” Account controls may set limits for individual transactions (e.g., a limit on transaction amount, geographic location, merchant, merchant category code, transaction time, transaction date, etc.) or for multiple transactions (e.g., an aggregate transaction amount, transaction frequency, number of transactions, etc.). In some instances, an account control may have multiple criteria, such as a control on the spending limit at a specific merchant over a specific period of time, for example, a limit of $100 to spend while attending the event.

The recipient mobile device may then be used in a payment transaction. The recipient may take the recipient mobile device to a merchant 108 for use in funding a payment transaction. As part of the transaction process, the recipient mobile device may convey the payment token to the merchant 108. Methods for conveyance of a payment token from a mobile device to a merchant 108 (e.g., via a merchant point of sale system) may include near field communication transmission, display and reading of a machine-readable code, etc.

The merchant 108 may receive the payment token and may submit the payment token along with transaction data for the payment transaction to a payment network 112. The submission may be made via the payment rails, and may be forwarded through, and in some instances modified, adjusted, reformatted, or otherwise changed, by one or more intermediate entities, such as an acquiring financial institution and a gateway processor. The payment network 112 may receive a transaction message for the payment transaction, which may be a specially formatted data message that is formatted pursuant to one or more standards governing the exchange of financial transaction messages, such as the International Organization of Standardization's ISO 8583 standard. The transaction message may include a plurality of data elements including a data element configured to store a primary account number, which may include the payment token provided by the recipient mobile device. The payment network 112 may identify the payment token and may forward the transaction message to the processing server 102 via the payment rails.

The processing server 102 may receive the transaction message and may identify the account profile involved in the payment transaction based on the payment token stored in the data element configured to store the primary account number for the transaction. The processing server 102 may then determine if the payment transaction is in compliance with the account controls set for the payment token, such as by comparing data values stored in the data elements in the transaction message with the account controls associated with the payment token. For example, if the account controls include a limit on the transaction amount for a specific merchant and an aggregate spending limit over a period of time, the processing server 102 may determine if the transaction amount for the transaction (e.g. as stored in the corresponding data element) is within the transaction amount limit if the merchant 108 is the specific merchant, and determine if the transaction would result in an aggregate spending amount for the period of time over the limit. The processing server 102 may provide an indication of the success or failure of the determination of compliance to the payment network 112 using the payment rails or a suitable alternative communication network. In some embodiments, the processing server 102 may swap the payment token stored in the corresponding data element for the primary account number associated with the transaction account.

In an exemplary embodiment, a consumer may via a consumer device 104 present a product for checkout at a POS terminal of a merchant 108. The merchant may communicate with a processing server 102, payment network 112, an acquirer 110, and/or an issuer 106 in order to complete the transaction. The processing server 102 may parse out data from the transaction and query a database 114 in order to provide a token linked to the consumer's loyalty account at the merchant 108 POS terminal for completing the transaction. The token may be transmitted to the consumer device 104 to present to the merchant 108 POS in order to complete the transaction.

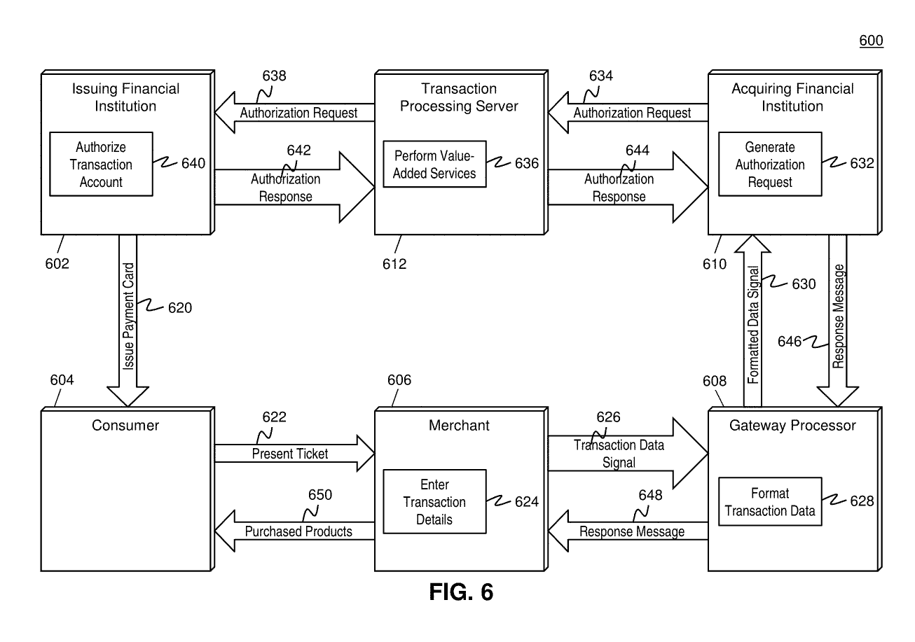

The payment network 112 may receive the indication and then may process the payment transactions accordingly using traditional methods. For example, if the processing server 102 determined that the transaction was not in compliance with the account controls, the payment network 112 may deny the transaction. The merchant 108 may be informed of the approval or denial of the payment transaction using traditional methods, and may finalize the transaction with the recipient and recipient mobile device accordingly. Additional information regarding the submission of transaction data from a merchant 108 to a payment network 112 and the processing of transaction messages and payment transactions is discussed in more detail below with respect to the process 600 illustrated in FIG. 6.

The methods and systems discussed herein may enable the provisioning of controlled payment tokens to secondary mobile devices using a more efficient process while retaining a high level of security and control. The technological improvements of the processing server 102 as discussed herein may ensure that payment tokens are only distributed to proper mobile devices through verification of the requesting device and via dual verification of the receiving device, and may improve the security of distributed tokens via the use of account controls. The result is a system 100 where the processing server 102 provides for a more useful method for the distribution of payment tokens to better utilize loyalty rewards without sacrificing the security or control granted by the use of payment tokens.

For example, the method and system may provide a tokenization and digitization service, which may convert a ticket and/or loyalty points account to a payment token for implementation via a mobile and/or digital device. When making a purchase, the consumer may tap (e.g., via contactless communication) or use remote payment (e.g., browser, in-app) to pay for the purchase at an in-store point of sale (POS) or in e-commerce point of interaction (POI). No merchant payment terminal changes may be required. In another embodiment, the merchant could also accept payment via a token linked to a cloud account (e.g., QR code linked to your digital token in the cloud).

When the transaction occurs, the tokenization service, may convert the token back to ticket number and/or loyalty account and the entity maintaining points balance can apply points as the payment. After the points are used, the balance can be covered using the associated payment card. A merchant whose points are being used can decide how many points and/or rewards are deducted. The amount covered by points can be shown to the consumer on either the payment terminal or consumer's digital interface before final payment. If, after the user of points and/or rewards, a balance remains, the digitization service may deliver the remaining charge to the issuer as normally. The payment method, (e.g. credit card, user has indicated to be used after points/rewards are used) will be used for the balance.

Some of the benefits provided by the system include providing the consumer access to all the currencies they have accumulated to make purchases including their loyalty points. The merchant 108 providing the loyalty program can offer better service to their loyal customers by expanding the usage of reward and loyalty points as part of the cost of any purchase can be covered by regular payment. Token accounts linked to points can be valid permanently or for limited time or in limited locations as determined by the points/rewards administrator. A merchant 108 can apply the amount of points they want. For example, merchants 108 could make points more valuable in their own merchant properties (e.g. flights and travel for airlines) and when used for other goods and services, the consumer may only get partial discount when using points. Merchants 108 can jointly agree how used points are settled between them. In some implementations, a third party exchange service can provide this settlement service. In addition, multiple rewards providers can jointly allow use of rewards increasing the efficiency the consumer can utilize rewards from various sources for a desired purchase. This system allows recognizing points as currencies and converts them to be used in the equivalent way.

### Processing Server

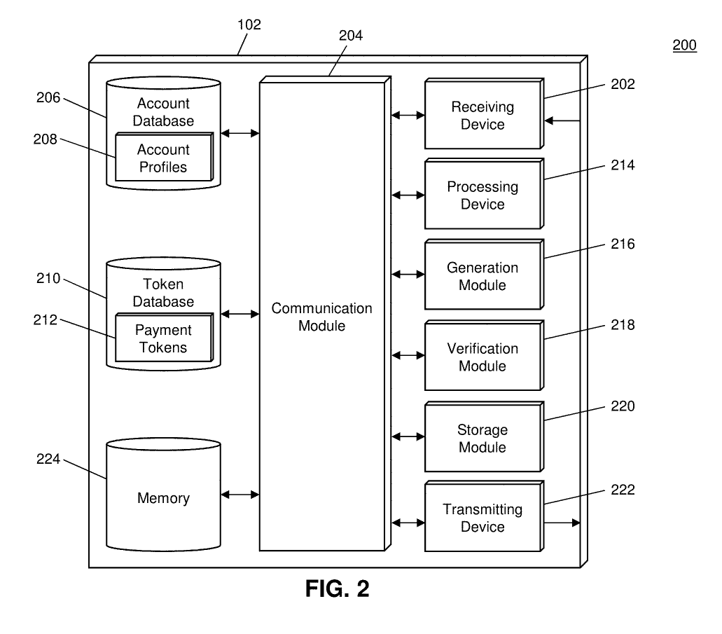

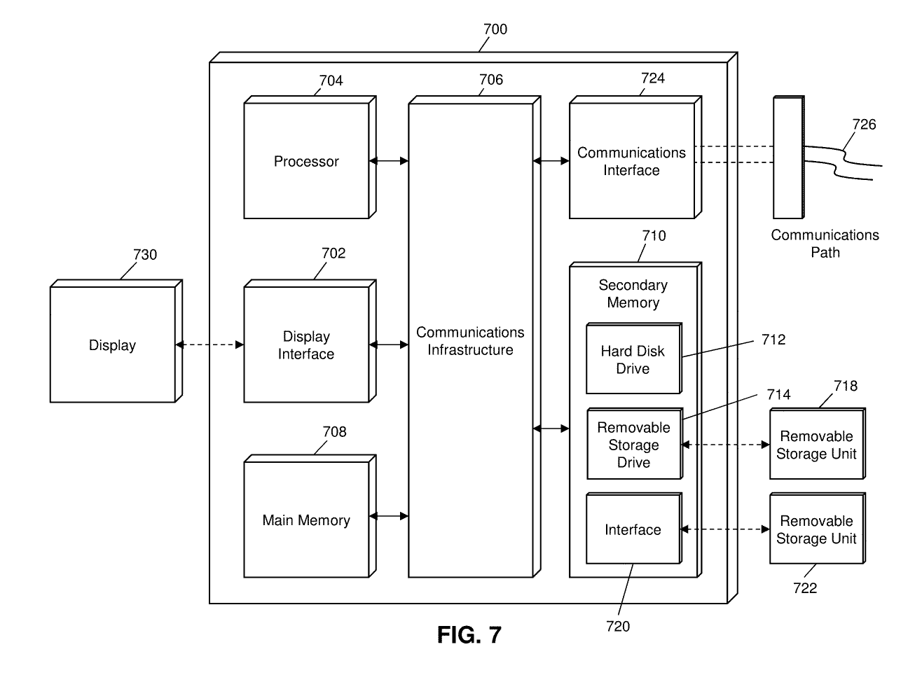

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 700 illustrated in FIG. 7 and discussed in more detail below may be a suitable configuration of the processing server 102.

The processing server 102 may include a receiving device 202. The receiving device 202 may be configured to receive data over one or more networks via one or more network protocols. In some embodiments, the receiving device 202 may be configured to receive data over the payment rails, such as using specially configured infrastructure associated with payment networks 112 for the transmission of transaction messages that include sensitive financial data and information. In some instances, the receiving device 202 may also be configured to receive data from consumer devices 104, recipient mobile devices, payment networks 112, and other entities via alternative networks, such as the Internet. In some embodiments, the receiving device 202 may be comprised of multiple devices, such as different receiving devices for receiving data over different networks, such as a first receiving device for receiving data over payment rails and a second receiving device for receiving data over the Internet. The receiving device 202 may receive electronically data signals that are transmitted, where data may be superimposed on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by the consumer device 104, which may be superimposed with token distribution requests. A token distribution request may include at least a device identifier associated with the consumer device 104, an account identifier, and a device identifier associated with a recipient mobile device. The token distribution request may also include account controls. In some instances, the receiving device 202 may be configured to receive data signals electronically transmitted by the consumer device 104 that are superimpose with account controls and/or other data used in the management of parent or child payment tokens for a transaction account to which the consumer device 104 is authorized.

The receiving device 202 may also be configured to receive data signals electronically transmitted by the recipient mobile device, which may be superimposed with token verification requests. Token verification requests may include at least a device identifier associated with the recipient mobile device and a reservation identifier and single use identification value used to verify the recipient mobile device for provisioning of a child payment token. The receiving device 202 may also be configured to receive transaction messages and other transaction data from payment networks 112, which may be electronically transmitted using the payment rails or other suitable communication networks, for use in the processing of payment transactions where payment tokens provisioned by the processing server 102 are used.

In some implementations, the receiving device 202 may receive a data signal from a consumer communication device, wherein the data signal is superimposed with a tokenization request, the tokenization request including at least a non-payment identifier. The receiving device 202 may receive a transaction authorization request to purchase an item. The transaction authorization request comprising the token linked to the non-payment identifier and a transaction amount for the item.

The receiving device 202 may receive a data signal from a consumer communication device. The data signal may be superimposed with a ticket purchase request. The ticket purchase request may include at least a ticket identifier and an account identifier.

The receiving device 202 may receive a transaction authorization request to purchase an item during the event, the transaction authorization request comprising the ticket identifier and a transaction amount for the item. The purchase of an item within the event may comprise one or more of: making purchases in a geographically bound location of the event, making purchases with particular vendors of the event, and making purchases within a time period of the event. The purchase of an item within the event may comprise one or more of: making purchases in a geographically bound location of the event, making purchases with particular vendors of the event, and making purchases within a time period of the event.

The receiving device 202 of the processing server may be configured to receive an authorization response with mapping of the PAN or loyalty account back to token.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc., as well as being configured to establish communication channels with outside systems and devices, such as the electronic point of sale device.

The processing server 102 may also include a processing device 214. The processing device 214 may be configured to perform the functions of the processing server 102 discussed herein as will be apparent to persons having skill in the relevant art.

The processing device 214 may be configured to determine if the token is being used for a purchase within the event. When, for example, the token is being used for the purchase within the event, the processing device 214 of the processing server may be configured to map the token to a PAN or a loyalty account when available.

The processing device 214 may be configured to determine an event ending and charge the account profile to provide payment for the amount charged to the ticket identifier during the event.

The processing device 214 may be configured to determine the quantity of points affiliated with the non-payment identifier. When, for example, the quantity of the points are equal to or greater than the transaction amount, the processing device 214 may withdraw the points needed from the quantity of points affiliated with the non-payment identifier for the transaction amount and approving the payment. When, for example, the quantity of points are less than the transaction amount, the processing device 214 may subtract the difference between the transaction amount and the quantity of points affiliated with the non-payment identifier and charge the difference to at least one of the PAN affiliated with the non-payment identifier and a PAN affiliated with a loyalty administrator account. When the quantity of points are less than the transaction amount, the processing server 102 may subtract the difference between the transaction amount and the quantity of points affiliated with the non-payment identifier, and charge the difference to the PAN affiliated with the non-payment identifier. In some implementations, wherein there are enough points to cover the transaction, the consumer will not be charged, however, the points and/or loyalty administrator's payment method may be charged to cover the transaction. In other implementations, where there are not enough points to cover the transaction, the points and/or loyalty administrator may pay for the covered amount, and the consumer may pay for the exceeding amount. In this case, two payment methods (e.g., PANs) may be used to cover the transaction. By design, both the consumer's backup payment method (e.g., consumer PAN) and the points and/or loyalty administrator's payment method (e.g., admin PAN) are linked to the non-payment account and its token. In some implementations, the points and/or loyalty administrator could also have another agreement with the merchant so that instead of payment in money, the charge could be accumulated and/or covered by reciprocity purchases or a similar swap. The de-tokenization service may then send the amount covered by the points to be paid by the points and/or loyalty administrator's payment method and the not-covered amount to be paid by the consumer's payment method.

In some embodiments, the processing device 214 may include and/or be comprised of a plurality of engines and/or modules specially configured to perform one or more functions of the processing device, such as a querying module, generation module 216, verification module 218, storage module 220, etc. As used herein, the term “module” may be software or hardware particularly programmed to receive an input, perform one or more processes using the input, and provide an output. The input, output, and processes performed by various modules will be apparent to one skilled in the art based upon the present disclosure.

The processing server 102 may include a memory 224. The memory 224 may be configured to store data for use by the processing server 102 in performing the functions discussed herein. The memory 224 may be configured to store data using suitable data formatting methods and schema and may be any suitable type of memory, such as read-only memory, random access memory, etc. The memory 224 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. The memory 224 may also include or be comprised of a relational database that utilizes structured query language for the storage, identification, modifying, updating, accessing, etc. of structured data sets stored therein.

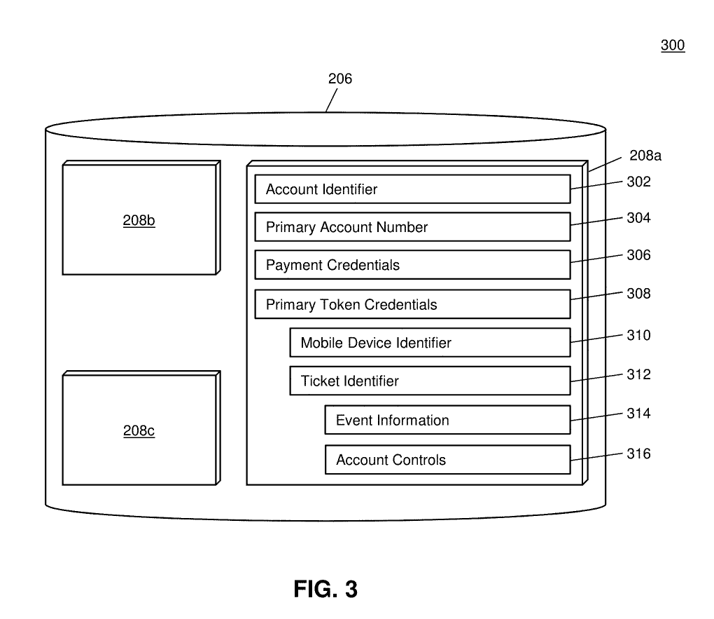

The processing server 102 may include an account database 206. The account database 206, illustrated in FIG. 3 and discussed in more detail below, may be configured to store a plurality of account profiles 208 using a suitable data storage format and schema. The account database 206 may be a relational database that utilizes structured query language for the storage, identification, modifying, updating, accessing, etc. of structured data sets stored therein. Each account profile 208 may be a structured data set configured to store data associated with a transaction account. Each account profile 208 may include, as discussed in more detail below, at least a primary account number associated with the related transaction account, at least one set of token credentials, and, for each set of token credentials, an associated mobile device identifier.

The account database 206 may store a plurality of account profiles. Each account profile may be a structured data set related to a transaction account including at least a non-payment identifier, at least one of a personal account number (PAN), and quantity of points affiliated with the non-payment identifier. The non-payment identifier may be for a loyalty account based on at least one of: an airline, a retail merchant, a gym, an employer, a gas station, a grocery store, a pharmacy, a hotel, a financial institution, a restaurant and/or affiliated with any other loyalty rewards program. The PAN comprises at least one of: a credit card, a debit card, a checking account number, and/or a savings account number.

In some implementations the account database 206 may store plurality of account profiles, wherein each account profile is a structured data set related to a transaction account including at least an account identifier, at least one of a personal account number (PAN) and a loyalty account, and/or at least one ticket identifier. The ticket identifier may permit access to an event. The event may be predefined by participating merchants. The account identifier may include at least one of: a phone number, application identifier, username, identification number, media access control address, device fingerprint, e-mail address, personal identification number, and/or authentication credentials.

In some embodiments, the processing server 102 may also include a token database 210. The token database 210 may be configured to store a plurality of payment tokens 212 using a suitable data storage format and schema. The token database 210 may be a relational database that utilizes structured query language for the storage, identification, modifying, updating, accessing, etc. of structured data sets stored therein. Each payment token 212 may be a structured data set configured to store payment credentials for a related transaction account suitable for use in funding a payment transaction. In some instances, the token database 210 may include a device identifier for each payment token 212 that has been provisioned to a mobile device. In such instances, an account profile 208 may not include payment tokens, but instead may be associated with the token database 210 whereby payment tokens 212 may be identified using device identifiers stored in the respective account profiles 208.

The processing server 102 may also include a querying module. The querying module may be configured to execute queries on databases to identify information. The querying module may receive one or more data values or query strings, and may execute a query string based thereon on an indicated database, such as the account database 206, to identify information stored therein. The querying module may then output the identified information to an appropriate engine or module of the processing server 102 as necessary. The querying module may, for example, execute a query on the account database 206 to identify an account profile 208 associated with a token distribution request received by the receiving device 202. Account profiles 208 may be identified via the data included therein, such as device identifiers, account identifiers, primary account numbers, and payment tokens.

The processing server 102 may also include a generation module 216. In some implementations, the generation module 216 may be configured to provision a token linking to the non-payment identifier. The non-payment identifier may be for a loyalty account based on at least one of: an airline, a retail merchant, a gym, an employer, a gas station, a grocery store, a pharmacy, a hotel, a financial institution, a restaurant and/or any other loyalty account.

In some implementations, the generation module 216 may be configured generate a token linked to the ticket identifier. The token may be limited to use for purchases within the event. The generation module 216 may be configured to generate data suitable for use in performing the functions of the processing server 102 discussed herein. The generation module 216 may receive a data request as input, may generate data based thereon, and may output the generated data to another engine or module of the processing server 102. The generation module 216 may be configured to generate reservation identifiers, which may be unique values generated randomly, pseudo-randomly, or using any suitable generation algorithm. The generation module 216 may also be configured to generate or otherwise identify single use identification values for use in verifying recipient consumer devices 104. In some embodiments, the generation module 216 may be configured to generate payment tokens for provisioning to mobile devices.

The processing server 102 may also include a verification module 218. The verification module 218 may be configured to verify data received via the receiving device 202 for use in performing the functions discussed herein. The verification module 218 may receive data as input, may verify the data, and may output a result of the verification to another module or engine of the processing server 102. In some instances, the verification module may receive two data sets to be verified against one another. In other instances, the verification module may receive a data set and may identify a second data set used in verification. The verification module 218 may be configured to, for example, verify a reservation identifier and single use identification value received from a recipient mobile device with a reservation identifier and single use identification value generated by the generation module 216. The verification module 218 may also be configured to verify compliance of a payment transaction with account controls based on transaction data stored in a received transaction message and account controls stored in a related account profile 208 identified via the querying module. In some instances, this may include account controls associated with child payment tokens, parent payment tokens, or transaction accounts generally.

The processing server 102 may also include a storage module 220. The storage module 220 may be configured to generate instructions for the querying module to execute to store data in the databases and memory 224 of the processing server 102. In some instances, the storage module 220 may be configured to generate, format, or otherwise setup data that is to be stored in the databases and memory 224 of the processing server 102. For example, the storage module 220 may be configured to generate new account profiles 208 for sender mobile devices 104 registering with the processing server 102. In another example, the storage module 220 may be configured to generate rules to be stored as account controls in account profiles 208 based on sender requests.

The processing server 102 may also include a transmitting device 222. The transmitting device 222 may be configured to transmit data over one or more networks via one or more network protocols. In some embodiments, the transmitting device 222 may be configured to transmit data over the payment rails, such as using specially configured infrastructure associated with payment networks 112 for the transmission of transaction messages that include sensitive financial data and information, such as identified payment credentials. In some instances, the transmitting device 222 may be configured to transmit data to sender mobile devices 104, recipient consumer devices 104, payment networks 112, and other entities via alternative networks, such as the Internet. In some embodiments, the transmitting device 222 may be comprised of multiple devices, such as different transmitting devices for transmitting data over different networks, such as a first transmitting device for transmitting data over the payment rails and a second transmitting device for transmitting data over the Internet. The transmitting device 222 may electronically transmit data signals that have data superimposed that may be parsed by a receiving computing device. In some instances, the transmitting device 222 may include one or more modules for superimposing, encoding, or otherwise formatting data into data signals suitable for transmission.

The transmitting device 222 may be configured to electronically transmit data signals to sender mobile devices 104 using a suitable communication network, which may be superimposed with data used in performing the functions disclosed herein. a transmitting device 222 of the processing server may be configured to transmit the token linked to the non-payment identifier to the consumer device 104. For example, the transmitting device 222 may electronically transmit single use identification values to a consumer device 104 to be used in provisioning a child payment token to a recipient mobile device. The transmitting device 222 may also be configured to electronically transmit data used in the management of an account profile 208 to a consumer device 104, such as notifications, preferences, settings, data requests, etc. The transmitting device 222 may also be configured to electronically transmit data signals to recipient consumer devices 104 via a suitable communication network. Data signals transmitted to recipient consumer devices 104 may be superimposed with provisioned payment tokens, account control notifications, reservation identifiers, and other data used in performing the functions discussed herein. The transmitting device 222 may also be configured to electronically transmit data signals to the payment network 112 via the payment rails or suitable alternative communication network, which may be superimposed with transaction messages and/or verification results.

### Account Database

FIG. 3 illustrates the account database 206 stored in the processing server 102 as illustrated in FIG. 2. The account database 206 may be configured to store a plurality of account profiles 208, illustrated in FIG. 3 as account profiles 208a, 208b, and 208c. Each account profile 208 may be a structured data set configured to store data related to a transaction account.

Each account profile 208 may include an account identifier 302. The account identifier 302 may be a unique value suitable for use in identifying the respective account profile 208. An account identifier 302 may be generated by the processing server 102 (e.g., by the generation module 216) using a suitable algorithm and/or process, or may be identified by a user (e.g., the sender) associated with the respective account profile 208. For example, the account identifier 302 may be a username, e-mail address, phone number, etc.

Each account profile 208 may also include a primary account number 304. The primary account number 304 may be an account number associated with the related transaction account, and may be used in the processing of payment transactions to be funded by the related transaction account. In some embodiment, an account profile 208 may also include payment credentials 306. The payment credentials 306 may be credentials associated with the related transaction account to be provided in a payment transaction in addition to the primary account number 304. Payment credentials 306 may include, for example, an application transaction counter, one or more payment cryptograms, etc.

Each account profile 208 may also include primary token credentials 308. The primary token credentials 308 may be a parent payment token and any associated credentials suitable for use in the processing of a payment transaction to be funded by the related transaction account. An account profile 208 may further include a mobile device identifier 310 for each set of primary token credentials 308. The mobile device identifier 310 may be a device identifier associated with a mobile device (e.g., the consumer device 104) to which the corresponding set of primary token credentials 308 was provisioned. A set of primary token credentials 308 may be for a parent payment token such that the mobile device corresponding to the associated mobile device identifier 310 may be allowed to request distribution of a child payment token to a recipient mobile device.

In instances where a child payment token has been provisioned for an account profile 208, the account profile 208 may include at least one set of child token credentials 312. Each set of child token credentials 312 may be for a child payment token provisioned to a recipient mobile device using the methods discussed herein. For each set of child token credentials 312, the account profile 208 may also include an associated mobile device identifier 314, which may be associated with the recipient mobile device to which the respective set of child token credentials 312 was provisioned. A payment token may be a set of child token credentials 312 such that the mobile device corresponding to the associated mobile device identifier 314 may be prohibited from requesting distribution of a subsequent child payment token. In some instances, the account profile 208 may include one or more account controls 316, which may be associated with a single set of child token credentials 312, multiple sets of child token credentials 312, each set of child token credentials 312 associated with a specific set of primary token credentials 308, or all sets of child token credentials 312 included in an account profile 208.

### Process for Tokenizing Reward Data

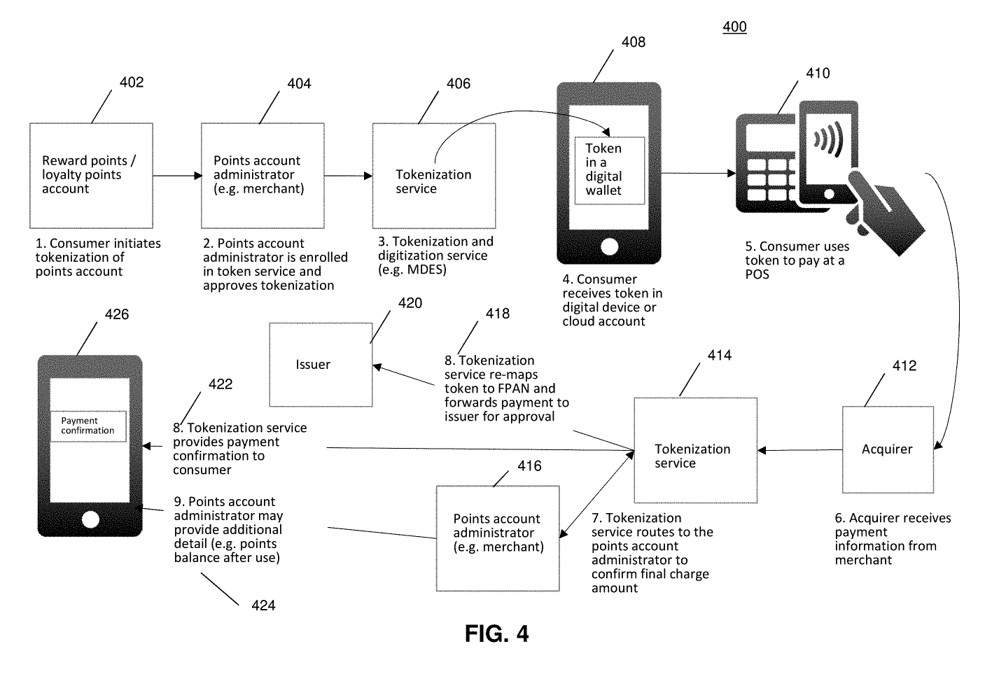

FIG. 4 is a flow diagram 400 illustrating a process for tokenization of reward data using the system of FIG. 1 in accordance with exemplary embodiments.

In step 402, a consumer may initiate tokenization of points with their loyalty and/or rewards point accounts via a consumer device (e.g., consumer device 104). There are, for example, hundreds of reward programs consumers can participate in. Some of the most well used are, for example, airline miles programs where each purchased ticket awards buyer points to be used for subsequent flights or at other locations included in the rewards program.

In step 404, a points account administrator may enroll the consumer in the token service and approve the tokenization. In some implementations, the points account administrator may be the merchant 108. For example, the service for tokenizing and digitizing points programs so that they can be used flexibly as payment vehicles that use points first and are also backed up by conventional, and more unlimited, funding method allowing all desired purchases whether the points balance is sufficient or not.

In step 406, the tokenization and digitization server may take place. In step 408, a consumer may receive a token in a digital device (e.g., consumer device 104), a cloud account, and/or it may be printed in the physical ticket which may provide access to the event. For example, the consumer purchases a flight using their credit card. With consumer's consent, the ticket is also simultaneously tokenized and digitized (by a token management service such as the MasterCard Digital Enablement Service) as a limited time payment method.

In step 410, the consumer may use the token to pay at a merchant (e.g., merchant 108) POS. For example, the event may be defined as the consumer's entire flight trip. During the trip consumer can simply pay by showing/tapping/providing their flight ticket token at any regular payment terminal on online merchant.

In step 412, an acquirer (e.g., acquirer 110) may receive the payment information from the merchant (e.g., merchant 108). In step 414, the tokenization service may route to the points account administrator to confirm the final charge amount. In step 416, the points account administrator (e.g., merchant 108).

In step 418, the tokenization server may re-map the token to the funding primary account number (FPAN) and forward the payment at step 420 to the issuer (e.g., 106) for approval. For example, the token service (e.g. MasterCard MDES), may de-tokenizes and re-map the token back to the ticket number and/or loyalty account and the airline can then apply miles for the charge first and if miles are not available provide the original credit card as the funding source for purchases. In some implementations, for example, when the quantity of points are less than the transaction amount, the processing server 102 may subtract the difference between the transaction amount and the quantity of points affiliated with the non-payment identifier, and charge the difference to the PAN affiliated with the non-payment identifier. In some implementations, wherein there are enough points to cover the transaction, the consumer will not be charged, however, the points and/or loyalty administrator's payment method may be charged to cover the transaction. In other implementations, where there are not enough points to cover the transaction, the points and/or loyalty administrator may pay for the covered amount, and the consumer may pay for the exceeding amount. In this case, two payment methods (e.g., PANs) may be used to cover the transaction. By design, both the consumer's backup payment method (e.g., consumer PAN) and the points and/or loyalty administrator's payment method (e.g., admin PAN) are linked to the non-payment account and its token. In some implementations, the points and/or loyalty administrator could also have another agreement with the merchant so that instead of payment in money, the charge could be accumulated and/or covered by reciprocity purchases or a similar swap. The de-tokenization service may then send the amount covered by the points to be paid by the points and/or loyalty administrator's payment method and the not-covered amount to be paid by the consumer's payment method.

At step 422, the tokenization server may provide payment confirmation to the consumer. At step 424, the points account administrator may provide additional detail (e.g., points balance after use) to the consumer. At step 426, the consumer may receive the payment confirmation and/or any other payment details on their consumer device (e.g., consumer device 104).

For example, a consumer's airline/store/service loyalty card may be tokenized and digitized as a payment option, which may be implemented at any merchant 108 terminal (e.g., at a point of sale using a chip card and/or digitized into a mobile/digital device and used contactless or in-app/browser). When a purchase is made with the loyalty account, the loyalty program will apply any applicable points first and apply a linked funding card to the balance.

### Exemplary Method for Tokenizing Reward Data

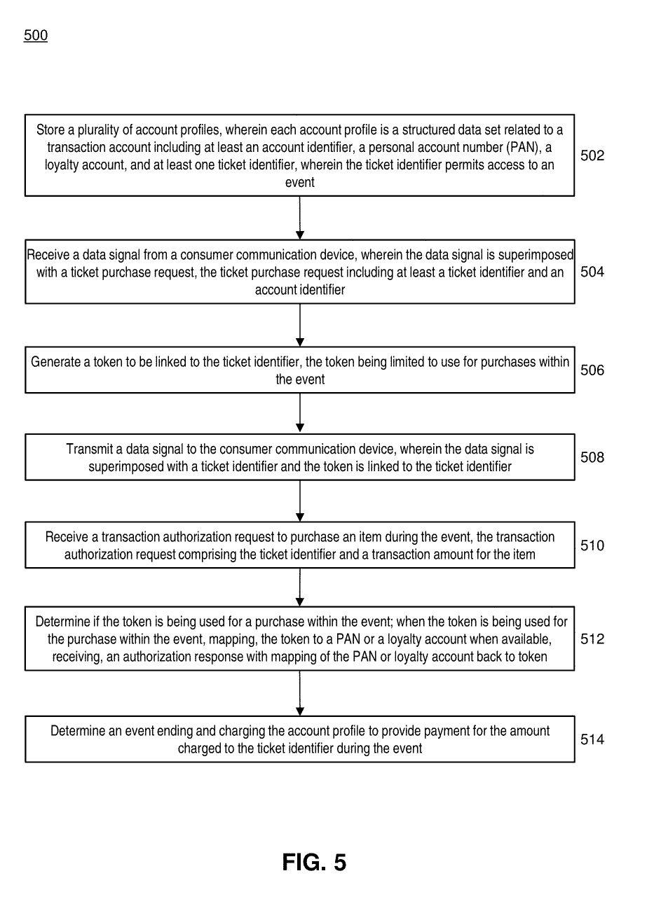

FIG. 5 is a flow chart 500 illustrating an exemplary method for tokenization of reward data in accordance with exemplary embodiments.

A method for linking a token to a ticket identifier may comprise several steps. At step 502, the method may be configured to store, in an account database (e.g., account database 206) of a processing server (e.g., processing server 102), a plurality of account profiles (e.g., account profiles 208). Each account profile may be a structured data set related to a transaction account including at least an account identifier, at least one of a personal account number (PAN) and a loyalty account, and at least one ticket identifier, wherein the ticket identifier permits access to an event. The event may be predefined by participating merchants. For example, when a consumer is flying, the event may be defined by the merchants providing services at the airport terminal. The event may last, for example, from when the consumer checks in at the airport to when the consumer arrives at their final destination. In some implementations, the event may allow the consumer to use loyalty and/or rewards points at the check in airport terminal, during their flight, and at the airport when the consumer lands. The account identifier may include at least one of: a phone number, application identifier, username, identification number, media access control address, device fingerprint, e-mail address, personal identification number, and/or authentication credentials.

At step 504, the method may be configured to receive, by a receiving device (e.g., receiving device 202) of the processing server (e.g., processing server 102), a data signal from a consumer communication device. The data signal may be superimposed with a ticket purchase request, the ticket purchase request including at least a ticket identifier and an account identifier.

At step 506, the method may be configured to generate, by a generation module (e.g., generation module 216) of the processing server (e.g., processing server 102), a token linked to the ticket identifier. The token may be limited to use for purchases within the event. The token may include a payment limit associated with the ticket identifier. The payment limit may be set by the consumer communication device.

At step 508, the method may be configured to transmit, by a transmitting device (e.g., transmitting device 222) of the processing server (e.g., processing server 102), a data signal to the consumer communication device. The data signal may be superimposed with a ticket identifier and the token linked to the ticket identifier.

At step 510, the method may be configured to receive, by the receiving device (e.g., receiving device 202) of the processing server (e.g., processing server 102), a transaction authorization request to purchase an item during the event. The transaction authorization request may comprise the ticket identifier and a transaction amount for the item. The purchase of an item within the event may comprise one or more of: making purchases in a geographically bound location of the event, making purchases with particular vendors of the event, and/or making purchases within a time period of the event. The purchase of an item within the event may comprise one or more of: making purchases in a geographically bound location of the event, making purchases with particular vendors of the event, and/or making purchases within a time period of the event.

At step 512, the method may be configured to determine, by a processing device (e.g., processing device 214) of the processing server (e.g., processing server 102), if the token is being used for a purchase within the event. When the token is being used for the purchase within the event, the processing device (e.g., processing device 214) may map the token to a PAN or a loyalty account when available. The receiving device (e.g., receiving device 202) may receive an authorization response with mapping of the PAN or loyalty account back to token.

At step 544, the method may be configured to determine, by the processing device (e.g., processing device 214) of the processing server (e.g., processing server 102), an event ending and charging the account profile to provide payment for the amount charged to the ticket identifier during the event. Charging the account profile may comprise utilizing loyalty points affiliated with the loyalty account.

### Payment Transaction Processing System and Process

FIG. 6 illustrates a transaction processing system and a process 600 for the processing of payment transactions in the system. The process 600 and steps included therein may be performed by one or more components of the system 100 discussed above, such as the processing server 102, consumer device 104, sender, recipient, recipient mobile device, merchant 108, payment network 112, etc. The processing of payment transactions using the system and process 600 illustrated in FIG. 6 and discussed below may utilize the payment rails, which may be comprised of the computing devices and infrastructure utilized to perform the steps of the process 600 as specially configured and programmed by the entities discussed below, including the transaction processing server 612, which may be associated with one or more payment networks configured to processing payment transactions. It will be apparent to persons having skill in the relevant art that the process 600 may be incorporated into the processes illustrated in FIGS. 4 and 5, discussed above, with respect to the step or steps involved in the processing of a payment transaction. In addition, the entities discussed herein for performing the process 600 may include one or more computing devices or systems configured to perform the functions discussed below. For instance, the merchant 606 may be comprised of one or more point of sale devices, a local communication network, a computing server, and other devices configured to perform the functions discussed below.

In step 620, an issuing financial institution 602 may issue a payment card or other suitable payment instrument to a consumer 604. The issuing financial institution may be a financial institution, such as a bank, or other suitable type of entity that administers and manages payment accounts and/or payment instruments for use with payment accounts that can be used to fund payment transactions. The consumer 604 may have a transaction account with the issuing financial institution 602 for which the issued payment card is associated, such that, when used in a payment transaction, the payment transaction is funded by the associated transaction account. In some embodiments, the payment card may be issued to the consumer 604 physically. In other embodiments, the payment card may be a virtual payment card or otherwise provisioned to the consumer 604 in an electronic format.

In step 622, the consumer 604 may present the issued payment card to a merchant 606 for use in funding a payment transaction. The merchant 606 may be a business, another consumer, or any entity that may engage in a payment transaction with the consumer 604. The payment card may be presented by the consumer 604 via providing the physical card to the merchant 606, electronically transmitting (e.g., via near field communication, wireless transmission, or other suitable electronic transmission type and protocol) payment details for the payment card, or initiating transmission of payment details to the merchant 606 via a third party. The merchant 606 may receive the payment details (e.g., via the electronic transmission, via reading them from a physical payment card, etc.), which may include at least a transaction account number associated with the payment card and/or associated transaction account. In some instances, the payment details may include one or more application cryptograms, which may be used in the processing of the payment transaction.

In step 624, the merchant 606 may enter transaction details into a point of sale computing system. The transaction details may include the payment details provided by the consumer 604 associated with the payment card and additional details associated with the transaction, such as a transaction amount, time and/or date, product data, offer data, loyalty data, reward data, merchant data, consumer data, point of sale data, etc. Transaction details may be entered into the point of sale system of the merchant 606 via one or more input devices, such as an optical bar code scanner configured to scan product bar codes, a keyboard configured to receive product codes input by a user, etc. The merchant point of sale system may be a specifically configured computing device and/or special purpose computing device intended for the purpose of processing electronic financial transactions and communicating with a payment network (e.g., via the payment rails). The merchant point of sale system may be an electronic device upon which a point of sale system application is run, wherein the application causes the electronic device to receive and communicated electronic financial transaction information to a payment network. In some embodiments, the merchant 606 may be an online retailer in an e-commerce transaction. In such embodiments, the transaction details may be entered in a shopping cart or other repository for storing transaction data in an electronic transaction as will be apparent to persons having skill in the relevant art.

In step 626, the merchant 606 may electronically transmit a data signal superimposed with transaction data to a gateway processor 608. The gateway processor 608 may be an entity configured to receive transaction details from a merchant 606 for formatting and transmission to an acquiring financial institution 610. In some instances, a gateway processor 608 may be associated with a plurality of merchants 606 and a plurality of acquiring financial institutions 610. In such instances, the gateway processor 608 may receive transaction details for a plurality of different transactions involving various merchants, which may be forwarded on to appropriate acquiring financial institutions 610. By having relationships with multiple acquiring financial institutions 610 and having the requisite infrastructure to communicate with financial institutions using the payment rails, such as using application programming interfaces associated with the gateway processor 608 or financial institutions used for the submission, receipt, and retrieval of data, a gateway processor 608 may act as an intermediary for a merchant 606 to be able to conduct payment transactions via a single communication channel and format with the gateway processor 608, without having to maintain relationships with multiple acquiring financial institutions 610 and payment processors and the hardware associated thereto. Acquiring financial institutions 610 may be financial institutions, such as banks, or other entities that administers and manages payment accounts and/or payment instruments for use with payment accounts. In some instances, acquiring financial institutions 610 may manage transaction accounts for merchants 606. In some cases, a single financial institution may operate as both an issuing financial institution 602 and an acquiring financial institution 610.

The data signal transmitted from the merchant 606 to the gateway processor 608 may be superimposed with the transaction details for the payment transaction, which may be formatted based on one or more standards. In some embodiments, the standards may be set forth by the gateway processor 608, which may use a unique, proprietary format for the transmission of transaction data to/from the gateway processor 608. In other embodiments, a public standard may be used, such as the International Organization for Standardization's ISO 6663 standard. The standard may indicate the types of data that may be included, the formatting of the data, how the data is to be stored and transmitted, and other criteria for the transmission of the transaction data to the gateway processor 608.

In step 628, the gateway processor 608 may parse the transaction data signal to obtain the transaction data superimposed thereon and may format the transaction data as necessary. The formatting of the transaction data may be performed by the gateway processor 608 based on the proprietary standards of the gateway processor 608 or an acquiring financial institution 610 associated with the payment transaction. The proprietary standards may specify the type of data included in the transaction data and the format for storage and transmission of the data. The acquiring financial institution 610 may be identified by the gateway processor 608 using the transaction data, such as by parsing the transaction data (e.g., deconstructing into data elements) to obtain an account identifier included therein associated with the acquiring financial institution 610. In some instances, the gateway processor 608 may then format the transaction data based on the identified acquiring financial institution 610, such as to comply with standards of formatting specified by the acquiring financial institution 610. In some embodiments, the identified acquiring financial institution 610 may be associated with the merchant 606 involved in the payment transaction, and, in some cases, may manage a transaction account associated with the merchant 606.

In step 630, the gateway processor 608 may electronically transmit a data signal superimposed with the formatted transaction data to the identified acquiring financial institution 610. The acquiring financial institution 610 may receive the data signal and parse the signal to obtain the formatted transaction data superimposed thereon. In step 632, the acquiring financial institution may generate an authorization request for the payment transaction based on the formatted transaction data. The authorization request may be a specially formatted transaction message that is formatted pursuant to one or more standards, such as the ISO 6663 standard and standards set forth by a payment processor used to process the payment transaction, such as a payment network. The authorization request may be a transaction message that includes a message type indicator indicative of an authorization request, which may indicate that the merchant 606 involved in the payment transaction is requesting payment or a promise of payment from the issuing financial institution 602 for the transaction. The authorization request may include a plurality of data elements, each data element being configured to store data as set forth in the associated standards, such as for storing an account number, application cryptogram, transaction amount, issuing financial institution 602 information, etc.

In step 634, the acquiring financial institution 610 may electronically transmit the authorization request to a transaction processing server 612 for processing. The transaction processing server 612 may be comprised of one or more computing devices as part of a payment network configured to process payment transactions. In some embodiments, the authorization request may be transmitted by a transaction processor at the acquiring financial institution 610 or other entity associated with the acquiring financial institution. The transaction processor may be one or more computing devices that include a plurality of communication channels for communication with the transaction processing server 612 for the transmission of transaction messages and other data to and from the transaction processing server 612. In some embodiments, the payment network associated with the transaction processing server 612 may own or operate each transaction processor such that the payment network may maintain control over the communication of transaction messages to and from the transaction processing server 612 for network and informational security.

In step 636, the transaction processing server 612 may perform value-added services for the payment transaction. Value-added services may be services specified by the issuing financial institution 602 that may provide additional value to the issuing financial institution 602 or the consumer 604 in the processing of payment transactions. Value-added services may include, for example, fraud scoring, transaction or account controls, account number mapping, offer redemption, loyalty processing, etc. For instance, when the transaction processing server 612 receives the transaction, a fraud score for the transaction may be calculated based on the data included therein and one or more fraud scoring algorithms and/or engines. In some instances, the transaction processing server 612 may first identify the issuing financial institution 602 associated with the transaction, and then identify any services indicated by the issuing financial institution 602 to be performed. The issuing financial institution 602 may be identified, for example, by data included in a specific data element included in the authorization request, such as an issuer identification number. In another example, the issuing financial institution 602 may be identified by the primary account number stored in the authorization request, such as by using a portion of the primary account number (e.g., a bank identification number) for identification.

In step 638, the transaction processing server 612 may electronically transmit the authorization request to the issuing financial institution 602. In some instances, the authorization request may be modified, or additional data included in or transmitted accompanying the authorization request as a result of the performance of value-added services by the transaction processing server 612. In some embodiments, the authorization request may be transmitted to a transaction processor (e.g., owned or operated by the transaction processing server 612) situated at the issuing financial institution 602 or an entity associated thereof, which may forward the authorization request to the issuing financial institution 602.

In step 640, the issuing financial institution 602 may authorize the transaction account for payment of the payment transaction. The authorization may be based on an available credit amount for the transaction account and the transaction amount for the payment transaction, fraud scores provided by the transaction processing server 612, and other considerations that will be apparent to persons having skill in the relevant art. The issuing financial institution 602 may modify the authorization request to include a response code indicating approval (e.g., or denial if the transaction is to be denied) of the payment transaction. The issuing financial institution 602 may also modify a message type indicator for the transaction message to indicate that the transaction message is changed to be an authorization response. In step 642, the issuing financial institution 602 may transmit (e.g., via a transaction processor) the authorization response to the transaction processing server 612.

In step 644, the transaction processing server 612 may forward the authorization response to the acquiring financial institution 610 (e.g., via a transaction processor). In step 646, the acquiring financial institution may generate a response message indicating approval or denial of the payment transaction as indicated in the response code of the authorization response, and may transmit the response message to the gateway processor 608 using the standards and protocols set forth by the gateway processor 608. In step 648, the gateway processor 608 may forward the response message to the merchant 606 using the appropriate standards and protocols. In step 650, the merchant 606 may then provide the products purchased by the consumer 604 as part of the payment transaction to the consumer 604, assuming the payment transaction is approved.

In some embodiments, once the process 600 has completed, payment from the issuing financial institution 602 to the acquiring financial institution 610 may be performed. In some instances, the payment may be made immediately or within one business day. In other instances, the payment may be made after a period of time, and in response to the submission of a clearing request from the acquiring financial institution 610 to the issuing financial institution 602 via the transaction processing server 612. In such instances, clearing requests for multiple payment transactions may be aggregated into a single clearing request, which may be used by the transaction processing server 612 to identify overall payments to be made by whom and to whom for settlement of payment transactions.

In some instances, the system may also be configured to perform the processing of payment transactions in instances where communication paths may be unavailable. For example, if the issuing financial institution is unavailable to perform authorization of the transaction account (e.g., in step 640), the transaction processing server 612 may be configured to perform authorization of transactions on behalf of the issuing financial institution 602. Such actions may be referred to as “stand-in processing,” where the transaction processing server “stands in” as the issuing financial institution 602. In such instances, the transaction processing server 612 may utilize rules set forth by the issuing financial institution 602 to determine approval or denial of the payment transaction, and may modify the transaction message accordingly prior to forwarding to the acquiring financial institution 610 in step 644. The transaction processing server 612 may retain data associated with transactions for which the transaction processing server 612 stands in, and may transmit the retained data to the issuing financial institution 602 once communication is reestablished. The issuing financial institution 602 may then process transaction accounts accordingly to accommodate for the time of lost communication.

In another example, if the transaction processing server 612 is unavailable for submission of the authorization request by the acquiring financial institution 610, then the transaction processor at the acquiring financial institution 610 may be configured to perform the processing of the transaction processing server 612 and the issuing financial institution 602. The transaction processor may include rules and data suitable for use in making a determination of approval or denial of the payment transaction based on the data included therein. For instance, the issuing financial institution 602 and/or transaction processing server 612 may set limits on transaction type, transaction amount, etc. that may be stored in the transaction processor and used to determine approval or denial of a payment transaction based thereon. In such instances, the acquiring financial institution 610 may receive an authorization response for the payment transaction even if the transaction processing server 612 is unavailable, ensuring that transactions are processed and no downtime is experienced even in instances where communication is unavailable. In such cases, the transaction processor may store transaction details for the payment transactions, which may be transmitted to the transaction processing server 612 (e.g., and from there to the associated issuing financial institutions 602) once communication is reestablished.

In some embodiments, transaction processors may be configured to include a plurality of different communication channels, which may utilize multiple communication cards and/or devices, to communicate with the transaction processing server 612 for the sending and receiving of transaction messages. For example, a transaction processor may be comprised of multiple computing devices, each having multiple communication ports that are connected to the transaction processing server 612. In such embodiments, the transaction processor may cycle through the communication channels when transmitting transaction messages to the transaction processing server 612, to alleviate network congestion and ensure faster, smoother communications. Furthermore, in instances where a communication channel may be interrupted or otherwise unavailable, alternative communication channels may thereby be available, to further increase the uptime of the network.

In some embodiments, transaction processors may be configured to communicate directly with other transaction processors. For example, a transaction processor at an acquiring financial institution 610 may identify that an authorization request involves an issuing financial institution 602 (e.g., via the bank identification number included in the transaction message) for which no value-added services are required. The transaction processor at the acquiring financial institution 610 may then transmit the authorization request directly to the transaction processor at the issuing financial institution 602 (e.g., without the authorization request passing through the transaction processing server 612), where the issuing financial institution 602 may process the transaction accordingly.

The methods discussed above for the processing of payment transactions that utilize multiple methods of communication using multiple communication channels, and includes fail safes to provide for the processing of payment transactions at multiple points in the process and at multiple locations in the system, as well as redundancies to ensure that communications arrive at their destination successfully even in instances of interruptions, may provide for a robust system that ensures that payment transactions are always processed successfully with minimal error and interruption. This advanced network and its infrastructure and topology may be commonly referred to as “payment rails,” where transaction data may be submitted to the payment rails from merchants at millions of different points of sale, to be routed through the infrastructure to the appropriate transaction processing servers 612 for processing. The payment rails may be such that a general purpose computing device may be unable to properly format or submit communications to the rails, without specialized programming and/or configuration. Through the specialized purposing of a computing device, the computing device may be configured to submit transaction data to the appropriate entity (e.g., a gateway processor 608, acquiring financial institution 610, etc.) for processing using this advanced network, and to quickly and efficiently receive a response regarding the ability for a consumer 604 to fund the payment transaction.

### Computer System Architecture

FIG. 7 illustrates a computer system 700 in which embodiments of the present disclosure, or portions thereof, may be implemented as computer-readable code. For example, the processing server 102 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 4-6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device specifically configured to perform the functions discussed herein. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., Wi-Fi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 4-6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

The processor device 704 may comprise one or more modules or engines configured to perform the functions of the computer system 700. Each of the modules or engines may be implemented using hardware and, in some instances, may also utilize software, such as corresponding to program code and/or programs stored in the main memory 708 or secondary memory 710. In such instances, program code may be compiled by the processor device 704 (e.g., by a compiling module or engine) prior to execution by the hardware of the computer system 700. For example, the program code may be source code written in a programming language that is translated into a lower level language, such as assembly language or machine code, for execution by the processor device 704 and/or any additional hardware components of the computer system 700. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 700 to perform the functions disclosed herein. It will be apparent to persons having skill in the relevant art that such processes result in the computer system 700 being a specially configured computer system 700 uniquely programmed to perform the functions discussed above.

Techniques consistent with the present disclosure provide, among other features, systems and methods for distributing controlled tokens to a secondary mobile device. While various exemplary embodiments of the disclosed system and method have been described above, it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for tokenizing non-payment identifier, comprising:
storing, in an account database of a processing server, a plurality of account profiles, wherein each account profile is a structured data set related to a transaction account including at least a non-payment identifier, at least one of a personal account number (PAN), and quantity of points affiliated with the non-payment identifier;
receiving, by a receiving device of the processing server, a data signal from a consumer communication device, wherein the data signal is superimposed with a tokenization request, the tokenization request including at least a non-payment identifier;
provisioning, by a generation module of the processing server, a token linking to the non-payment identifier; and
transmitting, by a transmitting device of the processing server, the token linked to the non-payment identifier to the consumer communication device.

2. The method of claim 1, further comprising:
receiving, by the receiving device of the processing server, a transaction authorization request to purchase an item, the transaction authorization request comprising the token linked to the non-payment identifier and a transaction amount for the item; and
determining, by the processing device of the processing server, the quantity of points affiliated with the non-payment identifier;
when the quantity of the points are equal to or greater than the transaction amount, withdrawing the points needed from the quantity of points affiliated with the non-payment identifier for the transaction amount and approving the payment, and
when the quantity of points are less than the transaction amount, subtracting the difference between the transaction amount and the quantity of points affiliated with the non-payment identifier, and charging the difference to at least one of the PAN affiliated with the non-payment identifier and a PAN affiliated with a loyalty administrator account.

3. The method of claim 1, wherein the non-payment identifier is for a loyalty account based on at least one of: an airline, a retail merchant, a gym, an employer, a gas station, a grocery store, a pharmacy, a hotel, a financial institution, and a restaurant.

4. The method of claim 1, wherein the PAN comprises at least one of: a credit card, a debit card, a checking account number, and a savings account number.

5. A method for linking a token to a ticket identifier, comprising:
storing, in an account database of a processing server, a plurality of account profiles, wherein each account profile is a structured data set related to a transaction account including at least an account identifier, at least one of a personal account number (PAN) and a loyalty account, and at least one ticket identifier, wherein the ticket identifier permits access to an event;
receiving, by a receiving device of the processing server, a data signal from a consumer communication device, wherein the data signal is superimposed with a ticket purchase request, the ticket purchase request including at least a ticket identifier and an account identifier;
generating, by a generation module of the processing server, a token linked to the ticket identifier, the token being limited to use for purchases within the event;
transmitting, by a transmitting device of the processing server, a data signal to the consumer communication device, wherein the data signal is superimposed with a ticket identifier and the token linked to the ticket identifier;
receiving, by the receiving device of the processing server, a transaction authorization request to purchase an item during the event, the transaction authorization request comprising the ticket identifier and a transaction amount for the item;
determining, by a processing device of the processing server, if the token is being used for a purchase within the event;
when the token is being used for the purchase within the event,
mapping, by the processing device of the processing server, the token to a PAN or a loyalty account when available,
receiving, by the receiving device of the processing server, an authorization response with mapping of the PAN or loyalty account back to token, and
determining, by the processing device of the processing server, an event ending and charging the account profile to provide payment for the amount charged to the ticket identifier during the event.

6. The method of claim 5, wherein the token includes a payment limit associated with the ticket identifier, wherein the payment limit is set by the consumer communication device.

7. The method of claim 5, wherein charging the account profile comprises utilizing loyalty points affiliated with the loyalty account.

8. The method of claim 5, wherein the purchase of an item within the event comprises one or more of: making purchases in a geographically bound location of the event, making purchases with particular vendors of the event, and making purchases within a time period of the event.

9. The method of claim 5, wherein the event is predefined by participating merchants.

10. The method of claim 5, wherein the account identifier includes at least one of: a phone number, application identifier, username, identification number, media access control address, device fingerprint, e-mail address, personal identification number, and authentication credentials.

11. A system for tokenizing a non-payment identifier+, comprising:
an account database of a processing server configured to store a plurality of account profiles, wherein each account profile is a structured data set related to a transaction account including at least a non-payment identifier, at least one of a personal account number (PAN), and quantity of points affiliated with the non-payment identifier;
a receiving device of the processing server configured to receive a data signal from a consumer communication device, wherein the data signal is superimposed with a tokenization request, the tokenization request including at least a non-payment identifier;
a generation module of the processing server configured to provision a token linking to the non-payment identifier; and
a transmitting device of the processing server configured to transmit the token linked to the non-payment identifier to the consumer communication device.

12. The system of claim 11, further comprising:
the receiving device of the processing server configured to receive a transaction authorization request to purchase an item, the transaction authorization request comprising the token linked to the non-payment identifier and a transaction amount for the item; and
the processing device of the processing server configured to determine the quantity of points affiliated with the non-payment identifier;
when the quantity of the points are equal to or greater than the transaction amount, withdrawing the points needed from the quantity of points affiliated with the non-payment identifier for the transaction amount and approving the payment, and
when the quantity of points are less than the transaction amount, subtracting the difference between the transaction amount and the quantity of points affiliated with the non-payment identifier, and charging the difference to at least one of the PAN affiliated with the non-payment identifier and a PAN affiliated with a loyalty administrator account.

13. The system of claim 11, wherein the non-payment identifier is for a loyalty account based on at least one of: an airline, a retail merchant, a gym, an employer, a gas station, a grocery store, a pharmacy, a hotel, a financial institution, and a restaurant.

14. The system of claim 11, wherein the PAN comprises at least one of: a credit card, a debit card, a checking account number, and a savings account number.

15. A system for linking a token to a ticket identifier, comprising:
an account database of a processing server configured to store a plurality of account profiles, wherein each account profile is a structured data set related to a transaction account including at least an account identifier, at least one of a personal account number (PAN) and a loyalty account, and at least one ticket identifier, wherein the ticket identifier permits access to an event;
a receiving device of the processing server configured to receive a data signal from a consumer communication device, wherein the data signal is superimposed with a ticket purchase request, the ticket purchase request including at least a ticket identifier and an account identifier;
a generation module of the processing server configured to generate a token linked to the ticket identifier, the token being limited to use for purchases within the event;
a transmitting device of the processing server configured to transmit a data signal to the consumer communication device, wherein the data signal is superimposed with a ticket identifier and the token linked to the ticket identifier;
the receiving device of the processing server configured to receive a transaction authorization request to purchase an item during the event, the transaction authorization request comprising the ticket identifier and a transaction amount for the item;
a processing device of the processing server configured to determine if the token is being used for a purchase within the event;
when the token is being used for the purchase within the event,
the processing device of the processing server configured to mapping the token to a PAN or a loyalty account when available,
the receiving device of the processing server configured to receive an authorization response with mapping of the PAN or loyalty account back to token, and
the processing device of the processing server configured to determine an event ending and charging the account profile to provide payment for the amount charged to the ticket identifier during the event.

16. The system of claim 15, wherein the token includes a payment limit associated with the ticket identifier, wherein the payment limit is set by the consumer communication device.

17. The system of claim 15, wherein charging the account profile comprises utilizing loyalty points affiliated with the loyalty account.

18. The system of claim 15, wherein the purchase of an item within the event comprises one or more of: making purchases in a geographically bound location of the event, making purchases with particular vendors of the event, and making purchases within a time period of the event.

19. The system of claim 15, wherein the event is predefined by participating merchants.

20. The system of claim 15, wherein the account identifier includes at least one of: a phone number, application identifier, username, identification number, media access control address, device fingerprint, e-mail address, personal identification number, and authentication credentials.
